(19) United States
(12) Patent Application Publication
(10) Pub. No.: US 2020/0041164 A1
(43) Pub. Date: Feb. 6, 2020

(54) AIR CONDITIONER CASE

(71) Applicant: DENSO CORPORATION, Kariya-city (JP)

(72) Inventors: Yasue YONEZU, Kariya-city (JP); Ayumi KAWASAKI, Kariya-city (JP); Koichiro BABA, Kariya-city (JP); Shun OMORI, Kariya-city (JP)

(21) Appl. No.: 16/597,744

(22) Filed: Oct. 9, 2019

Related U.S. Application Data
(63) Continuation of application No. PCT/JP2018/009057, filed on Mar. 8, 2018.

(30) Foreign Application Priority Data
Apr. 17, 2017 (JP) 2017-081471
Feb. 2, 2018 (JP) 2018-017277

(51) Int. Cl. F24F 13/20; B60H 1/00

(52) U.S. Cl. CPC F24F 13/20; B60H 1/00521; B60H 1/00528

(57) ABSTRACT

A recess that is provided at an end of a first case body includes an inner wall facing an air duct, an outer wall located on an outer side of a housing, and a bottom. A protrusion that is provided at an end of a second case body includes a tapered portion whose thickness in a cross sectional view gradually decreases from the second case body toward the bottom of the recess. The tapered portion is fitted between the inner wall and the outer wall of the recess. A taper angle is formed by a surface of the tapered portion facing the outer wall and a surface of the tapered portion facing the inner wall. The taper angle is larger than an internal angle formed by a surface of the outer wall facing the inner wall and a surface of the inner wall facing the outer wall.

### CROSS REFERENCE TO RELATED APPLICATION

The present application is a continuation application of International Patent Application No. PCT/JP2018/009057 filed on Mar. 8, 2018, which designated the U.S. and claims the benefit of priority from Japanese Patent Application No. 2017-081471 filed on Apr. 17, 2017, and Japanese Patent Application No. 2018-017277 filed on Feb. 2, 2018. The entire disclosures of all of the above applications are incorporated herein by reference.

### TECHNICAL FIELD

The present disclosure relates to an air conditioner case that forms a housing of an air conditioner.

### BACKGROUND

A conventionally known air conditioner case that forms a housing of an air conditioner is formed by combining a plurality of split cases.

### SUMMARY

According to an aspect of the present disclosure, an air conditioner case forming a housing of an air conditioner includes a first case body that defines an air duct through which air flows inside the housing; a second case body that defines the air duct inside the housing together with the first case body; a recess that is provided at an end of the first case body adjacent to the second case body, the recess including an inner wall facing the air duct, an outer wall located on an outer side of the housing, and a bottom that connects the inner wall and the outer wall on a side of the first case body; and a protrusion that is provided at an end of the second case body adjacent to the first case body, the protrusion including a tapered portion whose thickness in a cross sectional view gradually decreases from the second case body toward the bottom, the protrusion being fitted between the inner wall and the outer wall of the recess. A taper angle formed by a surface of the tapered portion facing the outer wall and a surface of the tapered portion facing the inner wall is larger than an internal angle formed by a surface of the outer wall facing the inner wall and a surface of the inner wall facing the outer wall.

### BRIEF DESCRIPTION OF THE DRAWINGS

FIG. 1 is an external view of an air conditioner including an air conditioner case according to a first embodiment.

FIG. 2 is a cross-sectional view taken along line II-II of FIG. 1.

FIG. 3 is an exploded view of FIG. 2.

FIG. 4 is a schematic view for explaining a fitted state of a first case and a second case included in the air conditioner case according to the first embodiment.

FIG. 5 is a schematic view for explaining a fitted state of a first case and a second case included in an air conditioner case of a first comparative example.

FIG. 6 is an exploded view of a part of an air conditioner case of a second embodiment.

FIG. 7 is a cross-sectional view of a part of the air conditioner case of the second embodiment.

FIG. 8 is an exploded view of a part of an air conditioner case of a second comparative example.

FIG. 9 is a cross-sectional view of a part of the air conditioner case of the second comparative example.

FIG. 10 is an exploded view of a part of an air conditioner case of a third embodiment.

FIG. 11 is a cross-sectional view of a part of the air conditioner case of the third embodiment.

FIG. 12 is an exploded view of a part of an air conditioner case of a fourth embodiment.

FIG. 13 is a cross-sectional view of a part of the air conditioner case of the fourth embodiment.

FIG. 14 is a graph illustrating an experimental result on a relationship between a surface pressure at which a scraping noise is generated and a surface roughness.

FIG. 15 is an exploded view of a part of an air conditioner case of a fifth embodiment.

FIG. 16 is an exploded view of a part of an air conditioner case of a sixth embodiment.

FIG. 17 is an exploded view of a part of an air conditioner case of a seventh embodiment.

FIG. 18 is a cross-sectional view of a part of a second case included in an air conditioner case of an eighth embodiment.

FIG. 19 is an enlarged view of area XIX of FIG. 18.

FIG. 20 is an explanatory view for explaining an example of a method for manufacturing the second case.

FIG. 21 is an explanatory view for explaining an example of the method for manufacturing the second case.

FIG. 22 is an enlarged view of area XXII of FIG. 21.

FIG. 23 is a cross-sectional view of a part of a first case included in an air conditioner case of a ninth embodiment.

FIG. 24 is an enlarged view of area XXIV of FIG. 22.

FIG. 25 is an explanatory view for explaining an example of a method for manufacturing the first case.

FIG. 26 is an explanatory view for explaining an example of the method for manufacturing the first case.

FIG. 27 is an enlarged view of area XVII of FIG. 26.

### EMBODIMENTS

### Comparative Example

An air conditioner case of a comparative example has a structure in which, among a plurality of split cases, a female portion (hereinafter referred to as a recess) provided in a recessed shape at an end of a first case is fitted with a male portion (hereinafter referred to as a protrusion) provided in a protruding shape at an end of a second case. The air conditioner case seals the connection between the first case and the second case by a contact surface between the recess and the protrusion or by a labyrinth structure formed by the recess and the protrusion.

In order to facilitate assembly of the split cases, a structure that fixes the split cases by a one touch clip without using a fastening member such as a screw has been adopted in recent years. In this case, relative movement is more likely to occur between the first case and the second case due to vibration transmitted from a vehicle, and when the pressure applied to the contact surface between the recess and the protrusion increases due to variations in the shape of the cases or deformation of the cases, a scraping noise may be generated from the contact surface. As a measure for suppressing the scraping noise, one can think of a method that increases the gap between the recess and the protrusion. However, if such a measure is taken, there is a concern that sealability of the connection between the first case and the second case is reduced.

Hereinafter, embodiments of the present disclosure will be described with reference to the drawings. Parts that are identical or equivalent to each other in the following embodiments are assigned the same reference numerals in the description.

### First Embodiment

A first embodiment will be described with reference to the drawings. An air conditioner case of the first embodiment forms a housing of an air conditioner mounted on a vehicle. The air conditioner draws in one or both of the air in a passenger compartment and the air outside the passenger compartment, regulates the temperature and humidity of the air drawn in, and blows the air into the passenger compartment, thereby performing air conditioning of the passenger compartment.

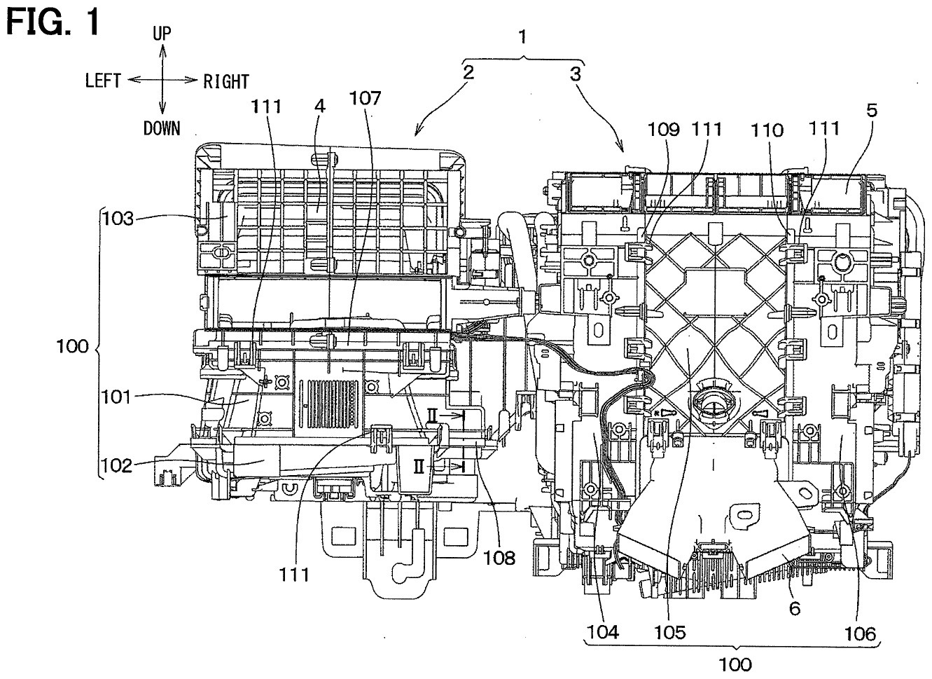

As illustrated in FIG. 1, an air conditioner 1 of the first embodiment includes a blower unit 2 and an air conditioning unit 3. A blower or the like not shown is disposed in an air duct formed inside the blower unit 2. An evaporator and a heater core or the like not shown are disposed in an air duct formed inside the air conditioning unit 3. In the air conditioner 1, the air taken into the air duct through an inside/outside air intake 4 by the drive of the blower is cooled by the evaporator and heated by the heater core, whereby the air is adjusted in temperature and humidity and can be blown into the passenger compartment from a plurality of blow-out openings 5 and 6.

The air conditioner case 100 includes a plurality of split cases adjacent to the blower unit 2 and a plurality of split cases adjacent to the air conditioning unit 3. FIG. 1 illustrates a blower upper case 101, a blower lower case 102, and an inside/outside air case 103 as the plurality of split cases adjacent to the blower unit 2. Moreover, a left unit case 104, a middle unit case 105, and a right unit case 106 are illustrated as the plurality of split cases adjacent to the air conditioning unit 3.

FIG. 1 uses arrows to indicate the left and right in the vehicle width direction and the vertical direction in a state where the air conditioner is mounted on a vehicle. In FIG. 1, a connection 107 between the blower upper case 101 and the inside/outside air case 103 is formed in the vehicle width direction. A connection 108 between the blower upper case 101 and the blower lower case 102 is also formed in the vehicle width direction. A connection 109 between the left unit case 104 and the middle unit case 105 is formed in the vertical direction. A connection 110 between the right unit case 106 and the middle unit case 105 is also formed in the vertical direction. Although not shown, each of the connections 107 to 110 is also provided on a surface on the vehicle front side, a surface on the vertical side, or a surface on the left and right side of the air conditioner case 100.

The connection between the plurality of split cases is assembled by a one touch clip 111. The air conditioner case 100 can thus assemble the plurality of split cases easily without using a fastening member such as a screw.

The air conditioner case 100 is made of resin having a certain degree of elasticity and excellent strength. For example, polypropylene can be used as the resin forming the air conditioner case 100. The resin forming the air conditioner case 100 is not limited to polypropylene but can be various resin materials.

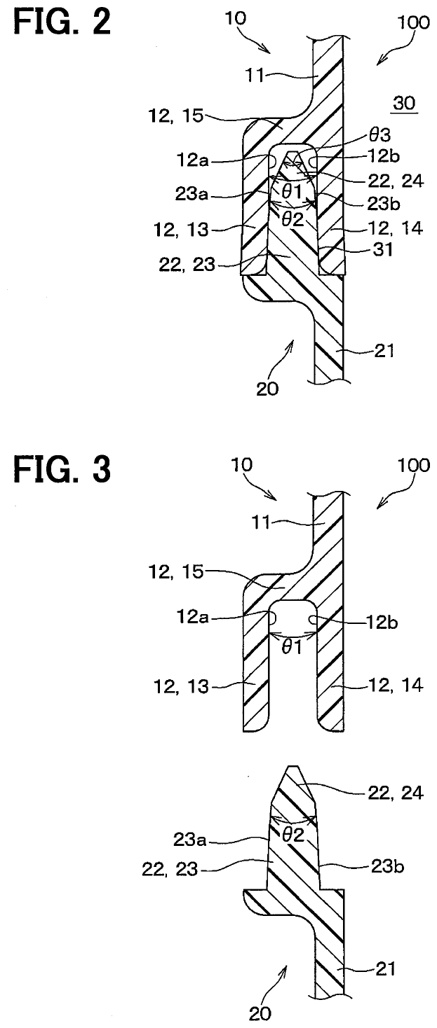

FIG. 2 is a cross-sectional view taken along line II-II of FIG. 1, and FIG. 3 is an exploded view of FIG. 2. In the following description, among the plurality of split cases included in the air conditioner case 100, one of the split cases disposed to be assembled together is referred to as a first case 10, while another one thereof is referred to as a second case 20. That is, the blower upper case 101 and the blower lower case 102, the blower upper case 101 and the inside/outside air case 103, the left unit case 104 and the middle unit case 105, and the right unit case 106 and the middle unit case 105 each correspond to an example of the first case 10 and the second case 20.

In FIGS. 2 and 3, the first case 10 and the second case 20 both extend continuously in the perpendicular direction of the paper surface of FIGS. 2 and 3. A first case body 11 and a recess 12 are integrally formed to be the first case 10. A second case body 21 and a protrusion 22 are integrally formed to be the second case 20. In a state where the first case 10 and the second case 20 are assembled, the first case body 11 and the second case body 21 together form an air duct 30 through which air flows inside the housing.

The recess 12 is provided at an end of the first case body 11 facing the second case body 21. The recess 12 includes an outer wall 13 located on a side of the outside air (that is, the outer side of the housing), an inner wall 14 located on a side of the air duct 30, and a bottom 15 connecting the outer wall 13 and the inner wall 14 facing the first case body 11. In the present specification, the outside air may refer to the air outside the housing. The outer wall 13 is provided on the side opposite to the air duct 30 with respect to the inner wall 14.

The protrusion 22 is provided at an end of the second case body 21 facing the first case body 11. The protrusion 22 is a portion fitted between the inner wall 14 and the outer wall 13 of the recess 12. The protrusion 22 includes a tapered portion 23 extending from the second case body 21 toward the bottom 15, and a tip 24 adjacent to the tapered portion 23 opposite to a side of the second case body 21. The tapered portion 23 is formed such that a thickness in a cross sectional view gradually decreases from the second case body 21 toward the bottom 15. The tip 24 is formed such that a taper angle θ3 in a cross sectional view is larger than a taper angle θ2 of the tapered portion 23. With the tip 24 provided on the protrusion 22, the protrusion 22 can be easily inserted into the opening of the recess 12.

FIGS. 2 and 3 each use an arrow with an angle θ1 to indicate the internal angle formed by a surface 12a of the outer wall 13 facing the inner wall 14 and a surface 12b of the inner wall 14 facing the outer wall 13 included in the recess 12. In the first embodiment, the internal angle θ1 of the recess 12 is 0° before the first case 10 and the second case 20 are assembled. That is, before the first case 10 and the second case 20 are assembled, the surface 12a of the outer wall 13 facing the inner wall 14 and the surface 12b of the inner wall 14 facing the outer wall 13 included in the recess 12 are formed in parallel.

Moreover, FIGS. 2 and 3 each use an arrow with an angle θ2 to indicate the taper angle formed by a surface 23a of the tapered portion 23 facing the outer wall 13 and a surface 23b of the tapered portion 23 facing the inner wall 14. In the first embodiment, the internal angle θ1 of the recess 12 and the taper angle θ2 of the tapered portion 23 are in the relationship of θ1<θ2.

Next, the significance of setting θ1<θ2 as the relationship between the internal angle θ1 of the recess 12 and the taper angle θ2 of the tapered portion 23 will be described.

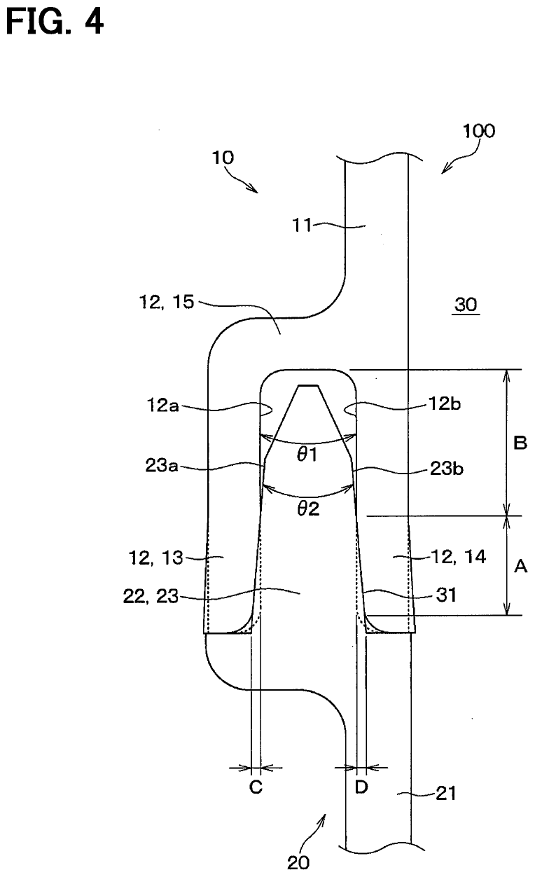

FIG. 4 is a schematic view for explaining a fitted state of the first case 10 and the second case 20, where the hatching is omitted to make broken lines and the like easy to see.

FIG. 4 uses solid lines to illustrate a state in which the recess 12 of the first case 10 and the protrusion 22 of the second case 20 are press-fitted. When the recess 12 of the first case 10 and the protrusion 22 of the second case 20 are press-fitted, a contact surface 31 between the recess 12 and the protrusion 22 is formed in a range indicated by arrow A. FIG. 4 indicates the distance between the contact surface 31 and the bottom 15 of the recess 12 by arrow B.

FIG. 4 uses broken lines to indicate the position when the recess 12 of the first case 10 and the protrusion 22 of the second case 20 are superimposed as is. The distance between the position of the recess 12 indicated by the broken lines and the outer wall of the tapered portion 23 corresponds to amounts of interference C and D between the recess 12 of the first case 10 and the protrusion 22 of the second case 20. When the recess 12 of the first case 10 and the protrusion 22 of the second case 20 are press-fitted, the outer wall 13 of the recess 12 is moved to the side of the outside air by the amount of interference C along the tapered portion 23, and the inner wall 14 of the recess 12 is moved to the side of the air duct 30 by the amount of interference D along the tapered portion 23.

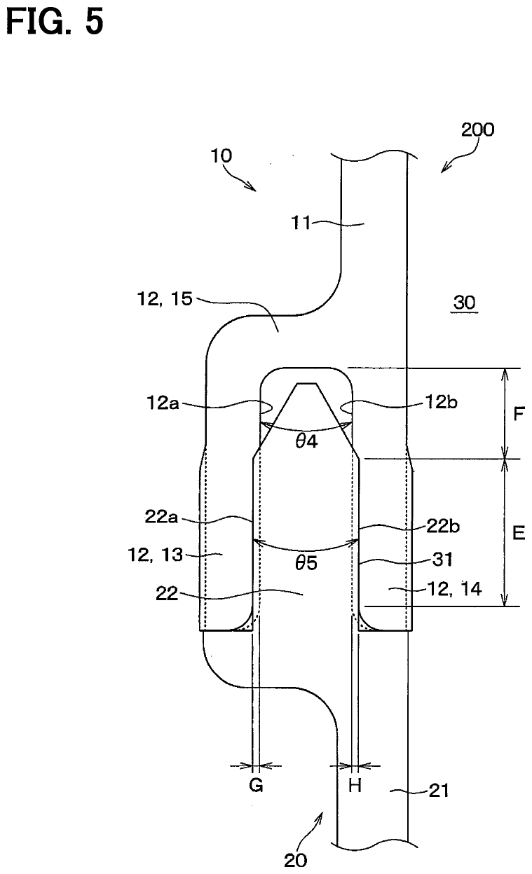

For the purpose of comparison with the air conditioner case 100 of the first embodiment described above, an air conditioner case 200 of a first comparative example will be described with reference to FIG. 5. FIG. 5 is also a schematic view for explaining a fitted state of the first case 10 and the second case 20 of the first comparative example, where the hatching is omitted to make broken lines and the like easy to see. In the first comparative example, the surface 12a of the outer wall 13 facing the inner wall 14 and the surface 12b of the inner wall 14 facing the outer wall 13 of the recess 12 are formed in parallel. A surface 22a facing the outer wall 13 and a surface 22b facing the inner wall 14 of the protrusion 22 are also formed in parallel. That is, in the first comparative example, an internal angle θ4 of the recess 12 of the first case 10 is 0°, and an angle θ5 formed by the surface of the protrusion 22 facing the outer wall 13 and the surface of the protrusion 22 facing the inner wall 14 of the second case 20 is also 0°.

FIG. 5 also uses solid lines to illustrate a state in which the recess 12 of the first case 10 and the protrusion 22 of the second case 20 are press-fitted. When the recess 12 of the first case 10 and the protrusion 22 of the second case 20 are press-fitted, the contact surface 31 between the recess 12 and the protrusion 22 is formed in a range indicated by arrow E. FIG. 5 indicates the distance between the contact surface 31 and the bottom 15 of the recess 12 by arrow F.

The distance F between the contact surface 31 and the bottom 15 of the comparative example illustrated in FIG. 5 is shorter than the distance B between the contact surface 31 and the bottom 15 of the first embodiment illustrated in FIG. 4. Accordingly, in the first comparative example, the reaction force acting on the contact surface 31 from the outer wall 13 and the inner wall 14 of the recess 12 is large. Therefore, the load required to press-fit the recess 12 and the protrusion 22 is larger in the first comparative example than in the first embodiment.

The range E of the contact surface 31 of the first comparative example illustrated in FIG. 5 is larger than the range A of the contact surface 31 of the first embodiment illustrated in FIG. 4. Accordingly, in the first comparative example, the pressure acting on the contact surface 31 between the protrusion 22 and the recess 12 is high so that the frictional resistance generated on the contact surface 31 is high. Thus, in the air conditioner case 200 of the first comparative example, a scraping noise may be generated from the contact surface 31 when relative movement occurs between the first case 10 and the second case 20 due to vibration of a vehicle, and the pressure applied to the contact surface 31 between the recess 12 and the protrusion 22 increases. The pressure applied to the contact surface 31 between the recess 12 and the protrusion 22 increases due to variations in the shape of the cases, deformation of the cases, or the like.

FIG. 5 also uses broken lines to indicate the position when the recess 12 of the first case 10 and the protrusion 22 of the second case 20 are superimposed as is. The distance between the position of the recess 12 indicated by the broken lines and the outer wall of the protrusion 22 corresponds to amounts of interference G and H between the recess 12 of the first case 10 and the protrusion 22 of the second case 20. The recess 12 of the first case 10 and the protrusion 22 of the second case 20 are press-fitted, so that the amounts of interference G and H of the comparative example illustrated in FIG. 5 are smaller than the amounts of interference C and D of the first embodiment illustrated in FIG. 4. For example, the amounts of interference G and H of the comparative example illustrated in FIG. 5 are each several tens of μm, and the amounts of interference C and D of the first embodiment illustrated in FIG. 4 are each one hundred and several tens of μm. However, these figures do not limit the scope of rights. The amounts of interference C and D of the first embodiment may be several tens of μm to several hundreds of μm. In the first comparative example, the amounts of interference G and H are small so that the sealability of the contact surface 31 between the protrusion 22 and the recess 12 may be reduced when the variations in the shape of the cases increase or the deformation of the cases increases.

With respect to the air conditioner case 200 of the first comparative example described above, the air conditioner case 100 of the first embodiment has the following effects. That is, in the air conditioner case 100 of the first embodiment, the taper angle θ2 of the tapered portion 23 of the protrusion 22 is larger than the internal angle θ1 of the recess 12, whereby the contact surface 31 between the protrusion 22 and the recess 12 is located far from the bottom 15. As a result, the reaction force acting on the contact surface 31 from the inner wall 14 and the outer wall 13 of the recess 12 is reduced, and the surface pressure acting on the contact surface 31 is reduced, whereby the frictional resistance (that is, the friction) generated on the contact surface 31 is reduced. The air conditioner case 100 can thus suppress generation of a scraping noise from the contact surface 31 even when the pressure is applied to the contact surface 31 due to variations in the shape of the cases, deformation of the cases, or the like and relative movement occurs between the first case 10 and the second case 20 due to vibration of a vehicle.

In the air conditioner case 100 of the first embodiment, the taper angle θ2 of the tapered portion 23 is larger than the internal angle θ1 of the recess 12. As a result, formation of a gap between the protrusion 22 and the recess 12 can be prevented by the elastic force of the inner wall 14 and the outer wall 13 of the recess 12 even when the protrusion 22 and the recess 12 are shifted in position in the direction of press-fitting. The air conditioner case 100 can thus improve the sealability of the contact surface 31.

In the air conditioner case 100 of the first embodiment, the reaction force acting on the protrusion 22 from the inner wall 14 and the outer wall 13 of the recess 12 is small when the protrusion 22 is press-fitted into the recess 12, whereby the load required to press-fit the recess 12 and the protrusion 22 is reduced. The air conditioner case 100 can thus improve the ease of assembly of the first case 10 and the second case 20.

### Second Embodiment

A second embodiment will be described. The second embodiment is similar to the first embodiment except that the configuration of the recess 12 of the first case 10 is changed from that of the first embodiment, whereby parts that are different from the first embodiment will only be described.

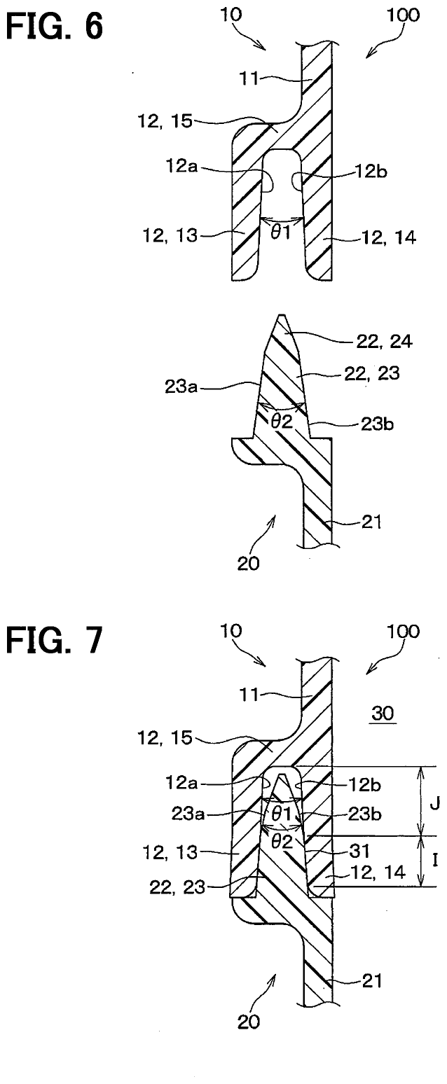

As illustrated in FIG. 6, the recess 12 of the second embodiment is formed in a tapered shape such that the space between the surface 12a of the outer wall 13 facing the inner wall 14 and the surface 12b of the inner wall 14 facing the outer wall 13 gradually increases from the side of the bottom 15 toward the second case body 21. Thus, the internal angle θ1 of the recess 12 of the first case 10 takes a value larger than 0°. However, in the second embodiment as well, the internal angle θ1 of the recess 12 and the taper angle θ2 of the tapered portion 23 are in the relationship of θ1<θ2 as in the first embodiment.

As illustrated in FIG. 7, the contact surface 31 between the recess 12 and the protrusion 22 is formed in a range indicated by arrow I. The range I of the contact surface 31 of the second embodiment illustrated in FIG. 7 is smaller than the range E of the contact surface 31 of the first comparative example illustrated in FIG. 5. Moreover, a distance J between the contact surface 31 and the bottom 15 of the second embodiment illustrated in FIG. 7 is larger than the distance F between the contact surface 31 and the bottom 15 of the first comparative example illustrated in FIG. 5. Therefore, the second embodiment can have the effect similar to that of the first embodiment described above.

The second embodiment sets the internal angle θ1 of the recess 12 to larger than 0° to be able to widen the opening of the recess 12 formed on the side opposite to the bottom 15. The air conditioner case 100 of the second embodiment can thus improve the ease of assembly of the first case 10 and the second case 20.

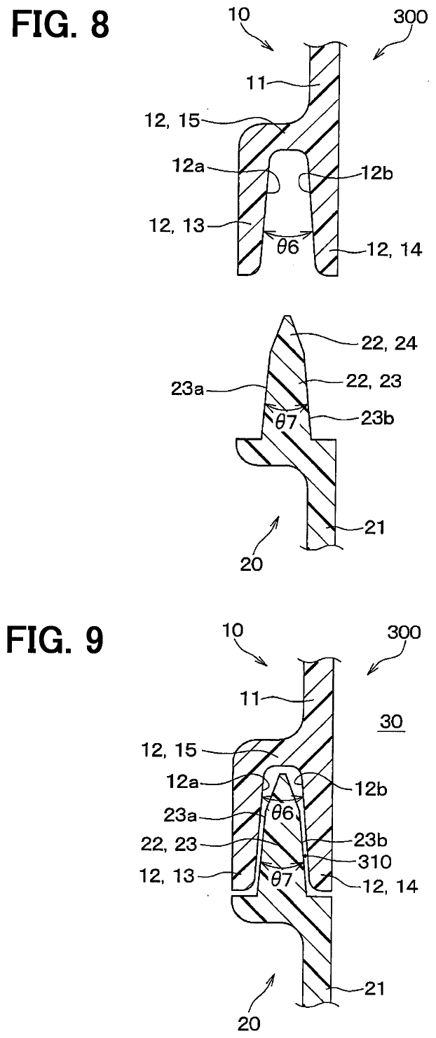

For the purpose of comparison with the air conditioner case 100 of the second embodiment described above, an air conditioner case 300 of a second comparative example will be described with reference to FIGS. 8 and 9.

In the second comparative example, as illustrated in FIGS. 8 and 9, the surface 12a of the outer wall 13 facing the inner wall 14 and the surface 12b of the inner wall 14 facing the outer wall 13 of the recess 12 are formed in a tapered shape. In the second comparative example, however, an internal angle θ6 of the recess 12 and a taper angle θ7 of the tapered portion 23 are in the relationship of θ6=∝7.

Thus, as illustrated in FIG. 9, a gap 310 is formed between the recess 12 and the protrusion 22 when the first case 10 and the second case 20 are shifted in position in the direction of press-fitting. The air conditioner case 300 of the second comparative example therefore has a problem that the sealability of the contact surface between the protrusion 22 and the recess 12 is reduced.

On the other hand, in the air conditioner case 100 of the first and second embodiments described above, the internal angle θ1 of the recess 12 and the taper angle θ2 of the tapered portion 23 are in the relationship of θ1<θ2 to thus be able to prevent formation of a gap between the protrusion 22 and the recess 12 by the elastic force of the inner wall 14 and the outer wall 13 of the recess 12 even if the protrusion 22 and the recess 12 are separated in the direction of press-fitting. The air conditioner case 100 of the first and second embodiments can thus improve the sealability of the contact surface 31 between the protrusion 22 and the recess 12.

### Third Embodiment

A third embodiment will be described. The third embodiment is similar to the first embodiment except that a part of the configuration of the protrusion 22 of the second case 20 is changed from that of the first embodiment, whereby parts that are different from the first embodiment will only be described.

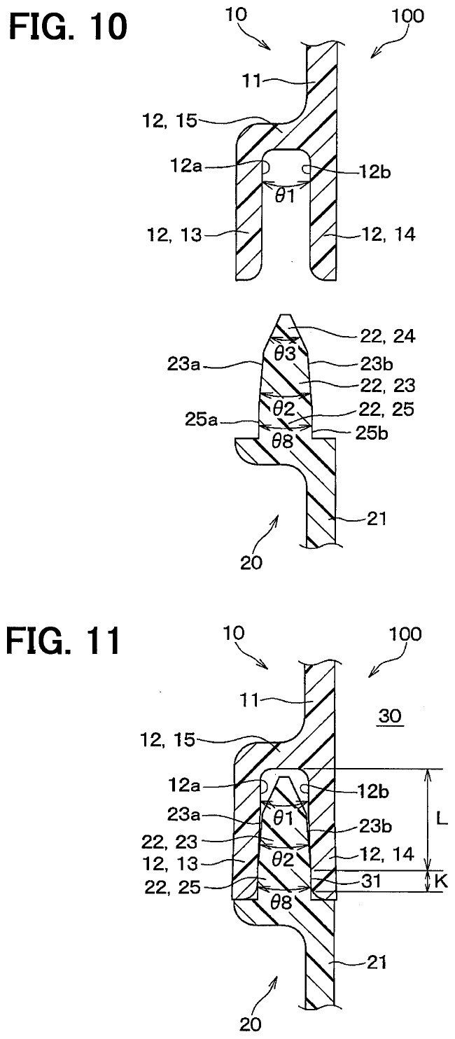

As illustrated in FIGS. 10 and 11, in the third embodiment, the protrusion 22 has a straight portion 25 with a change in the thickness in a cross sectional view smaller than that of the tapered portion 23 between the tapered portion 23 and the second case body 21. In the third embodiment, an angle θ8 formed by a surface 25a facing the outer wall 13 and a surface 25b facing the inner wall 14 of the straight portion 25 is 0°. Thus, in the straight portion 25, the surface 25a facing the outer wall 13 and the surface 25b facing the inner wall 14 are formed in parallel.

In the third embodiment, the straight portion 25 is in contact with the recess 12 in a region K illustrated in FIG. 11, whereby a distance L between the contact surface 31 and the bottom 15 can be further increased. As a result, the reaction force on the straight portion 25 from the inner wall 14 and the outer wall 13 of the recess 12 is reduced, and the surface pressure acting on the contact surface 31 between the straight portion 25 and the recess 12 is reduced, whereby the frictional resistance (that is, the friction) generated on the contact surface 31 is reduced. The air conditioner case 100 can thus suppress generation of a scraping noise from the contact surface 31.

### Fourth Embodiment

A fourth embodiment will be described. The fourth embodiment is similar to the first embodiment except that the configurations of the first case 10 and the second case 20 are changed from those of the first embodiment, whereby parts that are different from the first embodiment will only be described.

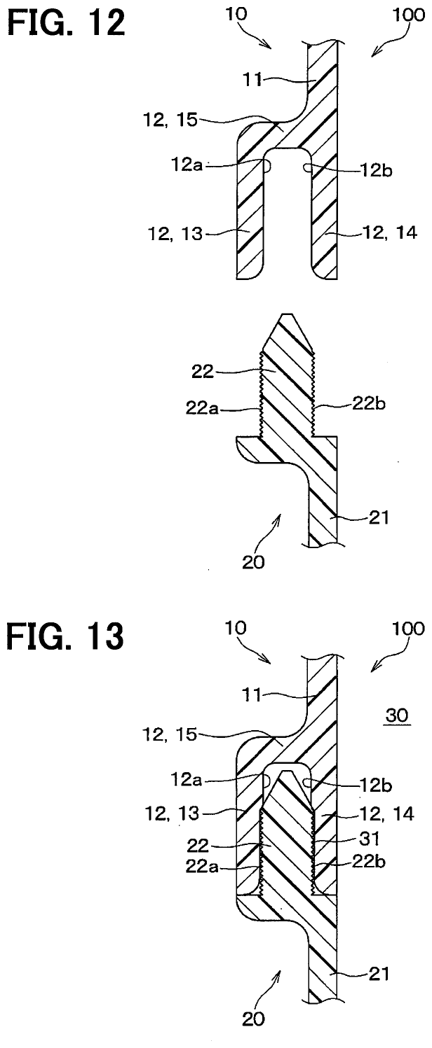

In the fourth embodiment, as illustrated in FIGS. 12 and 13, the surface 12a of the outer wall 13 facing the inner wall 14 and the surface 12b of the inner wall 14 facing the outer wall 13 of the recess 12 are formed in parallel. A surface 22a facing the outer wall 13 and a surface 22b facing the inner wall 14 of the protrusion 22 are also formed in parallel. That is, in the fourth embodiment, a tapered portion is not formed in the protrusion 22. Note that a tapered portion may be formed in the protrusion 22 in the fourth embodiment as in the first and second embodiments described above and a seventh embodiment described later.

In the fourth embodiment, a surface roughness of the surface 22a of the protrusion 22 facing the outer wall 13 and the surface 22b of the protrusion 22 facing the inner wall 14 is higher than a surface roughness of the first case body 11 or the second case body 21. For the sake of description, FIGS. 12 and 13 schematically enlarge the surface roughness formed on the surface 22a of the protrusion 22 facing the outer wall 13 and the surface 22b of the protrusion 22 facing the inner wall 14. Specifically, the surface roughness of the surface 22a of the protrusion 22 facing the outer wall 13 and the surface roughness of the surface 22b of the protrusion 22 facing the inner wall 14 each equal Rz 10 or higher in the ten-point average roughness, for example. The surface roughness may be increased depending on the rigidity of a vehicle or the like. In that case, the surface roughness of the surface 22a of the protrusion 22 facing the outer wall 13 and the surface roughness of the surface 22b of the protrusion 22 facing the inner wall 14 are preferably Rz 20 or higher, more preferably Rz 25 or higher, for example. When the recess 12 and the protrusion 22 are press-fitted, the surface 12a of the outer wall 13 of the recess 12 facing the protrusion 22 interferes with the surface 22a of the protrusion 22 facing the outer wall 13, and the surface 12b of the inner wall 14 of the recess 12 facing the protrusion 22 interferes with the surface 22b of the protrusion 22 facing the inner wall 14.

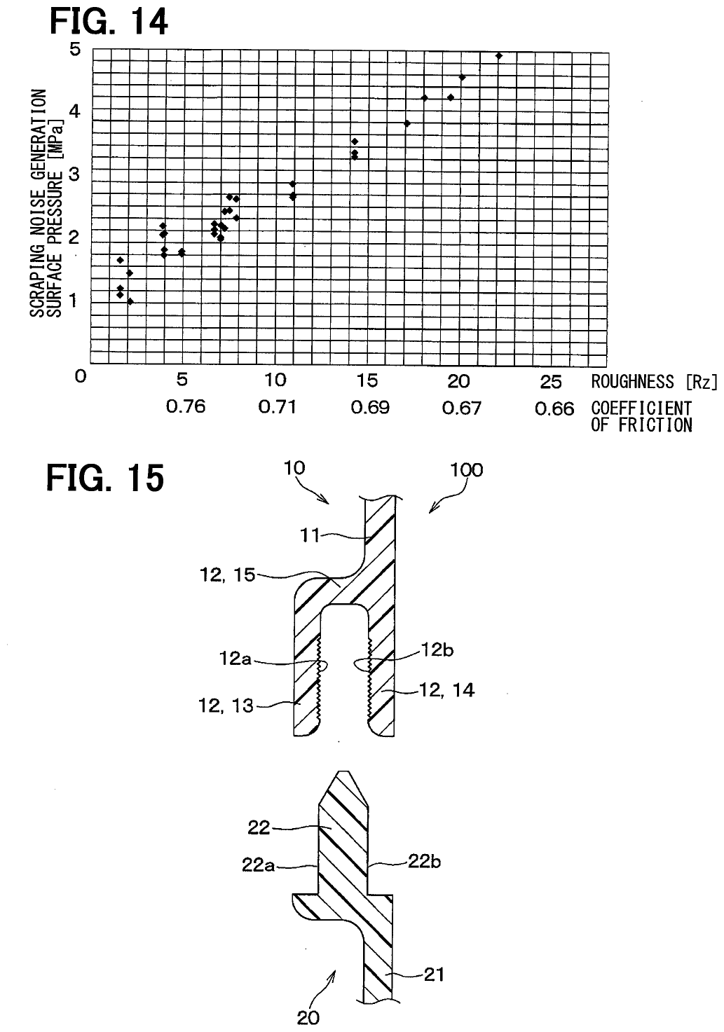

FIG. 14 illustrates a result of an experiment conducted by the inventor on the relationship between the surface pressure at which a scraping noise is generated and the surface roughness.

In the experiment, a plurality of test bodies made of polypropylene with surface roughness imparted to an end face of each of the test bodies was prepared. Then, the end face of each test body to which surface roughness was imparted was brought into contact with an end face of another test body to which surface roughness was not imparted, and the surface pressure at which a scraping noise was generated was examined by rubbing the two test bodies together under load.

A horizontal axis of FIG. 14 represents the surface roughness imparted to the test body and a corresponding coefficient of friction. The greater the surface roughness imparted to the test body, the lower the coefficient of friction. A vertical axis represents the surface pressure when a scraping noise is generated from the contact surface between the two test bodies. A result of the measurement of the surface pressure when the scraping noise was generated for each test body was plotted on the graph.

According to the result of the experiment, it was found that no scraping noise is generated with the surface pressure of smaller than 2.5 MPa when the surface roughness imparted to the test body is Rz 10 or higher. In general, in a conventional air conditioner case to which surface roughness is not imparted, the first case body 11, the second case body 21, the recess 12, and the protrusion 22 all have the surface roughness of Rz 5 or lower. According to the experiment, there is a possibility that a scraping noise is generated with the surface pressure of smaller than 2.5 MPa when the surface roughness of the test body is Rz 5 or lower. Therefore, if the surface roughness of at least one of the contact surface 31 between the recess 12 and the protrusion 22 is Rz 10 or higher, the generation of a scraping noise can be suppressed even when the contact surface 31 is subjected to the surface pressure of 2.5 MPa at which a scraping noise may be generated in the conventional air conditioner case 100. The surface pressure acting on the contact surface 31 between the recess 12 and the protrusion 22 varies depending on the rigidity of a vehicle or the like. Therefore, the surface roughness imparted to the protrusion 22 or the recess 12 may be increased depending on the rigidity of a vehicle or the like. In that case, the surface roughness imparted to the protrusion 22 or the recess 12 is preferably Rz 20 or higher, more preferably Rz 25 or higher, for example.

In the fourth embodiment described above, the surface roughness of the surface 22a of the protrusion 22 facing the outer wall 13 and the surface 22b of the protrusion 22 facing the inner wall 14 is higher than the surface roughness of the first case body 11 or the second case body 21. As a result, the coefficient of friction of the contact surface 31 between the recess 12 and the protrusion 22 is reduced, and the frictional resistance on the contact surface 31 can be reduced. The air conditioner case 100 can thus suppress generation of a scraping noise from the contact surface 31.

### Fifth Embodiment

A fifth embodiment will be described. The fifth embodiment is similar to the fourth embodiment except that the area where the roughness is formed is changed from that of the fourth embodiment, whereby parts that are different from the fourth embodiment will only be described. The fifth to seventh embodiments described below will each illustrate only an exploded view of the first case 10 and the second case 20, but the description of each part will be made on the assumption that the cases are assembled.

In the fifth embodiment, as illustrated in FIG. 15, a surface roughness of the surface 12a of the outer wall 13 of the recess 12 facing the protrusion 22 and a surface roughness of the surface 12b of the inner wall 14 of the recess 12 facing the protrusion 22 are each higher than the surface roughness of the first case body 11 or the second case body 21. FIG. 15 also schematically illustrates the surface roughness formed on the surface 12a of the outer wall 13 of the recess 12 facing the protrusion 22 and the surface 12b of the inner wall 14 of the recess 12 facing the protrusion 22. The configuration of the fifth embodiment can also reduce the coefficient of friction of the contact surface 31 between the recess 12 and the protrusion 22, and reduce the frictional resistance on the contact surface 31. Therefore, the fifth embodiment can also have the same effect as that of the fourth embodiment described above.

### Sixth Embodiment

A sixth embodiment will be described. The sixth embodiment is a combination of the fourth embodiment and the fifth embodiment.

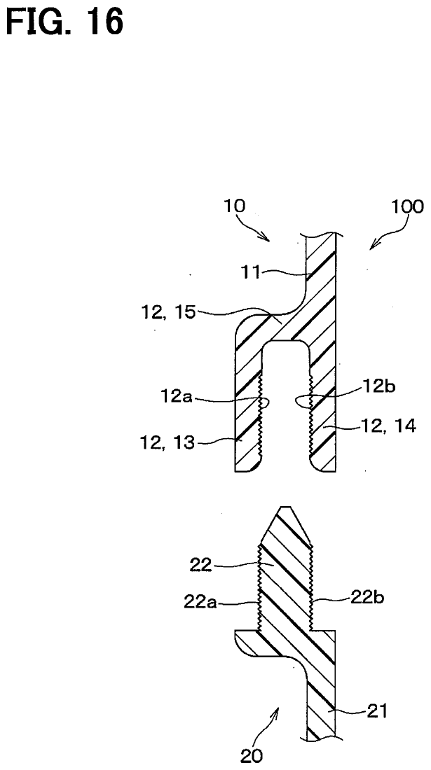

In the sixth embodiment, as illustrated in FIG. 16, the surface roughness of the surface 22a of the protrusion 22 facing the outer wall 13 and the surface roughness of the surface 22b of the protrusion 22 facing the inner wall 14 are each higher than the surface roughness of the first case body 11 or the second case body 21. Moreover, the surface roughness of the surface 12a of the outer wall 13 of the recess 12 facing the protrusion 22 and the surface roughness of the surface 12b of the inner wall 14 of the recess 12 facing the protrusion 22 are each higher than the surface roughness of the first case body 11 or the second case body 21. The configuration of the sixth embodiment can also reduce the coefficient of friction of the contact surface 31 between the recess 12 and the protrusion 22, and reduce the frictional resistance on the contact surface 31. Therefore, the sixth embodiment can also have the same effect as that of the fourth and fifth embodiments described above.

### Seventh Embodiment

A seventh embodiment will be described. The seventh embodiment is a combination of the first embodiment and the fourth embodiment.

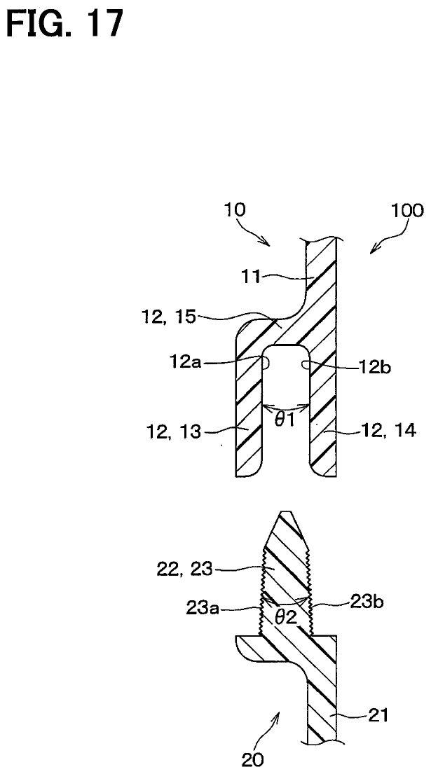

In the seventh embodiment, as illustrated in FIG. 17, the protrusion 22 of the second case 20 has the tapered portion 23 with the thickness in a cross sectional view gradually decreasing from the second case body 21 toward the bottom 15, as in the first embodiment. The internal angle θ1 of the recess 12 and the taper angle θ2 of the tapered portion 23 are in the relationship of θ1<θ2.

In the seventh embodiment, a surface roughness of the surface 23a facing the outer wall 13 and a surface roughness of the surface 23b facing the inner wall 14 of the tapered portion 23 are each higher than the surface roughness of the first case body 11 or the second case body 21. Therefore, the seventh embodiment can have the same effect as that of the first to sixth embodiments described above.

### Eighth Embodiment

An eighth embodiment will be described. The eighth embodiment illustrates the detailed shape of a rough surface formed on the tapered portion 23 of the protrusion 22 of the second case 20 included in the air conditioner case 100, and an example of a manufacturing method for forming the rough surface on the tapered portion 23. The “rough surface” is also referred to as “surface roughening”, and refers to a part of the surface of the air conditioner case 100 where the surface roughness is higher than that of the second case body 21 or the first case body 11.

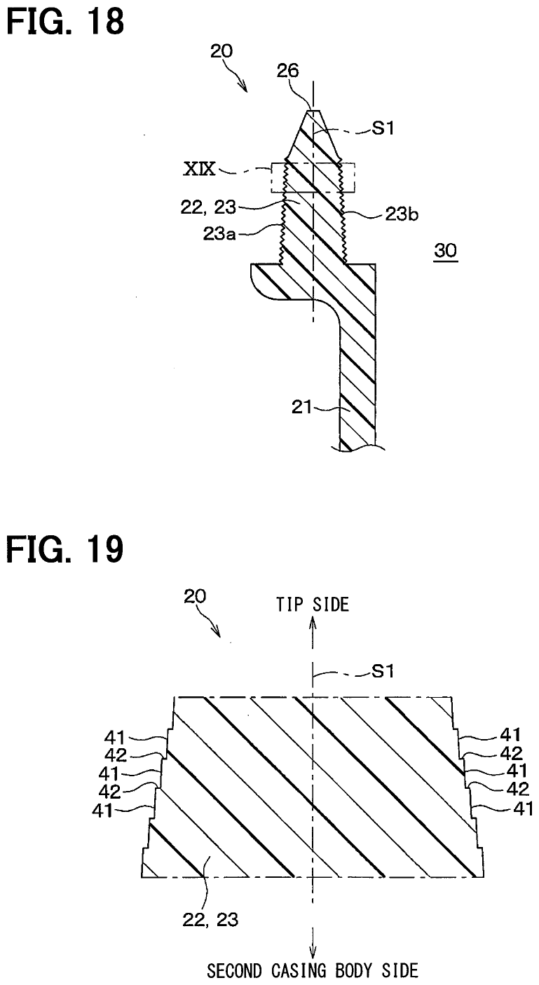

In the eighth embodiment as well, as illustrated in FIG. 18, the protrusion 22 of the second case 20 has the tapered portion 23 with the thickness in a cross sectional view gradually decreasing from the second case body 21 toward a tip 26, as in the seventh embodiment and the like described above. The surface roughness of the surface 23b of the tapered portion 23 facing the air duct 30 and a surface roughness of the surface 23a of the tapered portion 23 on a side opposite to the side of the air duct 30 are each higher than the surface roughness of the second case body 21. The irregularities on the surface indicated by reference characters 23a and 23b in FIG. 18 indicate the location of the rough surface formed on the tapered portion 23 of the protrusion 22, and do not indicate the orientation of the irregularities on the rough surface.

FIG. 19 is an enlarged view of the area indicated by reference character XIX in FIG. 18, and schematically illustrates the detailed shape of the rough surface formed on the tapered portion 23 of the protrusion 22 of the second case 20. As illustrated in FIG. 19, the rough surface formed on the tapered portion 23 of the protrusion 22 of the second case 20 has at least a plurality of first surfaces 41 and a plurality of second surfaces 42. In the following description, a center plane between the surface 23b of the tapered portion 23 facing the air duct 30 and the surface 23a of the tapered portion 23 on the side opposite to the side of the air duct 30 is referred to as a center plane S1. The plurality of first surfaces 41 is inclined toward the center plane S1 from the side of the second case body 21 to the side of the tip 26. Each of the second surfaces 42 connects a portion facing the tip 26 of a predetermined one of the first surfaces 41 and a portion facing the second case body 21 of another one of the first surfaces 41 that is disposed on a side of the tip 26 relative to the predetermined first surface 41. As a result, the rough surface formed on the tapered portion 23 of the protrusion 22 has a shape that can be formed by die cutting of normal injection molding without having an undercut shape in resin injection molding.

The plurality of first surfaces 41 and the plurality of second surfaces 42 are not limited to flat surfaces but may be curved surfaces. Moreover, the connection between the first surface 41 and the second surface 42 may be smooth without being angular.

Next, an example of the manufacturing method for forming the rough surface on the tapered portion 23 of the protrusion 22 of the second case 20 will be described. The method for manufacturing the second case 20 of the present embodiment is not limited to the method described below.

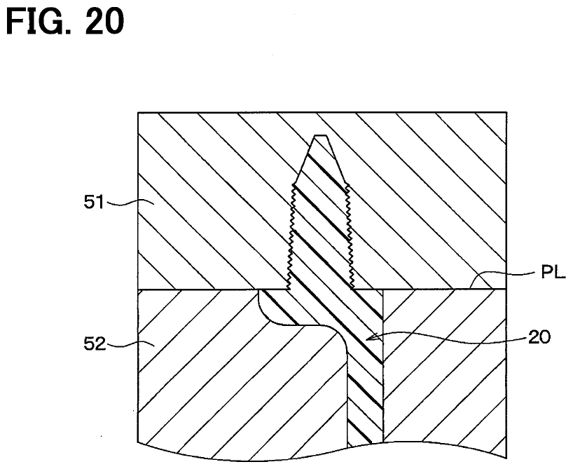

As illustrated in FIG. 20, the second case 20 is formed by resin injection molding. FIG. 20 uses reference character PL to indicate a parting line between a first mold 51 and a second mold 52. In resin injection molding, after the first mold 51 and the second mold 52 are closed, a heat-melted resin is injected into a space (that is, a product portion) formed between the first mold 51 and the second mold 52, and then cooled and solidified to form the second case 20.

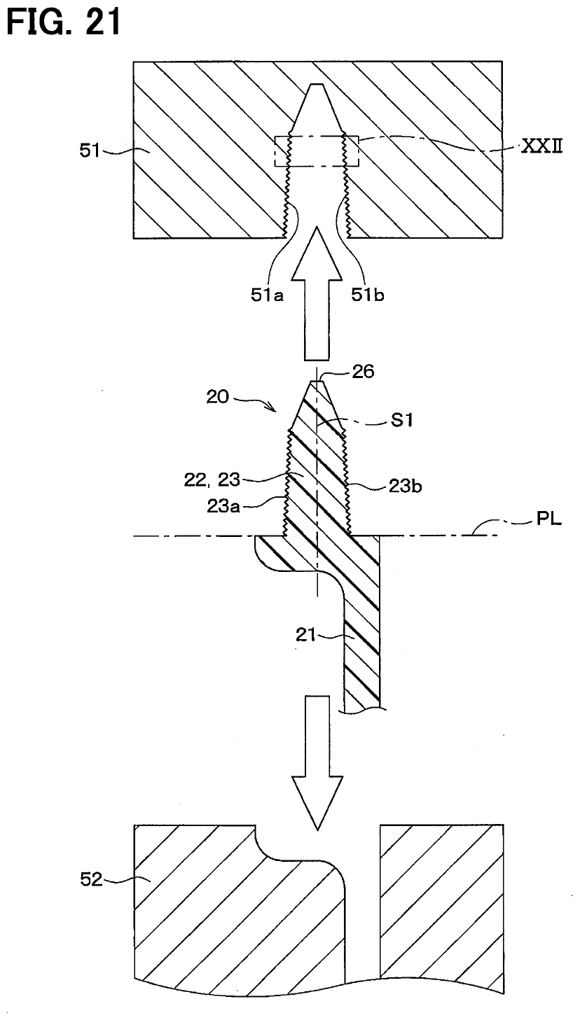

As illustrated in FIG. 21, in a mold opening process of the resin injection molding, the first mold 51 forming the protrusion 22 of the second case 20 is moved substantially in parallel to the center plane S1 of the tapered portion 23. The irregularities indicated by reference characters 51a and 51b in FIG. 21 indicate the location of a rough surface forming portion for forming the rough surface on a resin molded product (that is, the tapered portion 23 of the protrusion 22) in the first mold 51, and do not indicate the orientation of the irregularities of the rough surface forming portion.

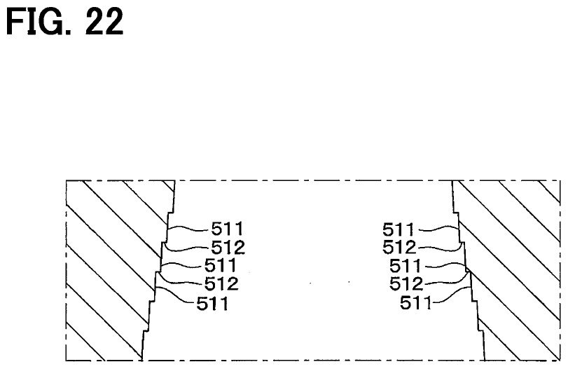

FIG. 22 is an enlarged view of the area indicated by reference character XXII in FIG. 21, and schematically illustrates the detailed shape of the rough surface forming portion in the first mold 51. As illustrated in FIG. 22, the rough surface forming portion of the first mold 51 has a plurality of first forming surfaces 511 for forming the first surfaces 41 of the rough surface on the tapered portion 23 of the protrusion 22, and a plurality of second forming surfaces 512 for forming the second surfaces 42 of the rough surface on the tapered portion 23 of the protrusion 22. The plurality of first forming surfaces 511 and the plurality of second forming surfaces 512 are inclined such that the tapered portion 23 of the protrusion 22 can be cut out from the first mold 51. Therefore, the manufacturing method can perform mold opening by moving the first mold 51 substantially in parallel to the center plane S1 of the tapered portion 23 without providing a special mold structure such as a slide core in the first mold 51.

In the eighth embodiment described above, the tapered portion 23 is provided on the protrusion 22 of the second case 20 included in the air conditioner case 100, so that the rough surface formed on the tapered portion 23 can have the shape that can be formed by die cutting of normal injection molding. Therefore, the eighth embodiment can reduce the manufacturing cost by simplifying the structure of the first mold 51.

### Ninth Embodiment

A ninth embodiment will be described. The ninth embodiment illustrates the detailed shape of a rough surface formed on the inner wall 14 and the outer wall 13 of the recess 12 of the first case 10 included in the air conditioner case 100, and an example of a manufacturing method for forming the rough surface on the inner wall 14 and the outer wall 13 of the recess 12.

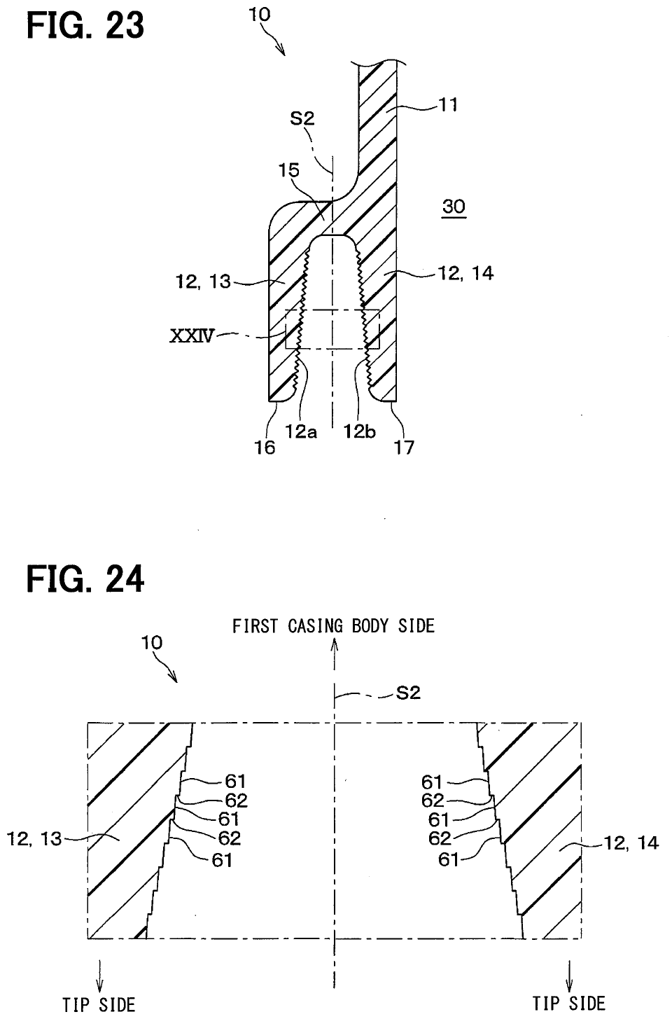

As illustrated in FIG. 23, the recess 12 of the first case 10 is formed in a tapered shape. Specifically, the recess 12 is formed in the tapered shape such that the space between the surface 12a of the outer wall 13 facing the inner wall 14 and the surface 12b of the inner wall 14 facing the outer wall 13 gradually decreases from the side of corresponding tips 16 and 17 toward the first case body 11. The surface roughness of the surface 12a of the outer wall 13 of the recess 12 facing the inner wall 14 and the surface roughness of the surface 12b of the inner wall 14 of the recess 12 facing the outer wall 13 are each higher than the surface roughness of the first case body 11. The irregularities on the surface indicated by reference characters 12a and 12b in FIG. 23 indicate the location of the rough surface formed in the recess 12, and do not indicate the orientation of the irregularities on the rough surface.

FIG. 24 is an enlarged view of the area indicated by reference character XXIV in FIG. 23, and schematically illustrates the detailed shape of the rough surface formed in the recess 12 of the first case 10. As illustrated in FIG. 24, the rough surface formed in the recess 12 of the first case 10 has at least a plurality of first surfaces 61 and a plurality of second surfaces 62. In the following description, a center plane between the surface 12a of the outer wall 13 of the recess 12 facing the inner wall 14 and the surface 12b of the inner wall 14 of the recess 12 facing the outer wall 13 is referred to as a center plane S2. The plurality of first surfaces 61 is inclined toward the center plane S2 from the side of the tip 16 of the outer wall 13 or the side of the tip 17 of the inner wall 14 to the side of the first case body 11. Each of the second surfaces 62 connects a portion facing the first case body 11 of a predetermined one of the first surfaces 61 and a portion facing the tip 16 or 17 of the outer wall 13 or the inner wall 14 of another one of the first surfaces 61 that is disposed on a side of the first case body 11 relative to the predetermined first surface 61. As a result, the rough surface formed on the inner wall 14 and the outer wall 13 of the recess 12 has a shape that can be formed by die cutting of normal injection molding without having an undercut shape in resin injection molding.

The plurality of first surfaces 61 and the plurality of second surfaces 62 are not limited to flat surfaces but may be curved surfaces. Moreover, the connection between the first surface 61 and the second surface 62 may be smooth without being angular.

Next, an example of the manufacturing method for forming the rough surface on the inner wall 14 and the outer wall 13 of the recess 12 of the first case 10 included in the air conditioner case 100 will be described. The method for manufacturing the first case 10 of the present embodiment is not limited to the method described below.

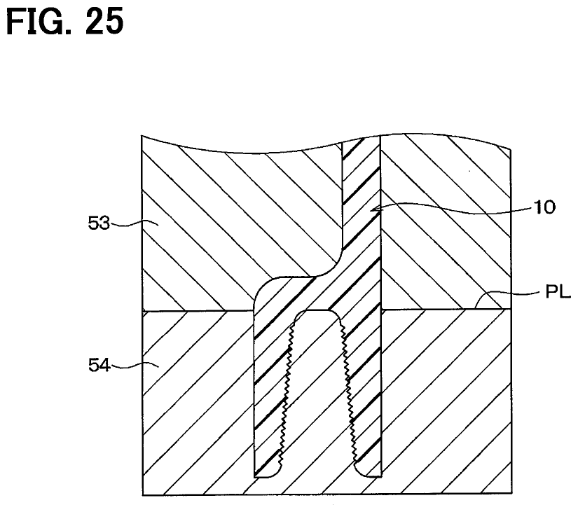

As illustrated in FIG. 25, the first case 10 is also formed by resin injection molding. FIG. 25 uses reference character PL to indicate a parting line between a third mold 53 and a fourth mold 54. In resin injection molding, after the third mold 53 and the fourth mold 54 are closed, a heat-melted resin is injected into a space (that is, a product portion) formed between the third mold 53 and the fourth mold 54, and then cooled and solidified to form the first case 10.

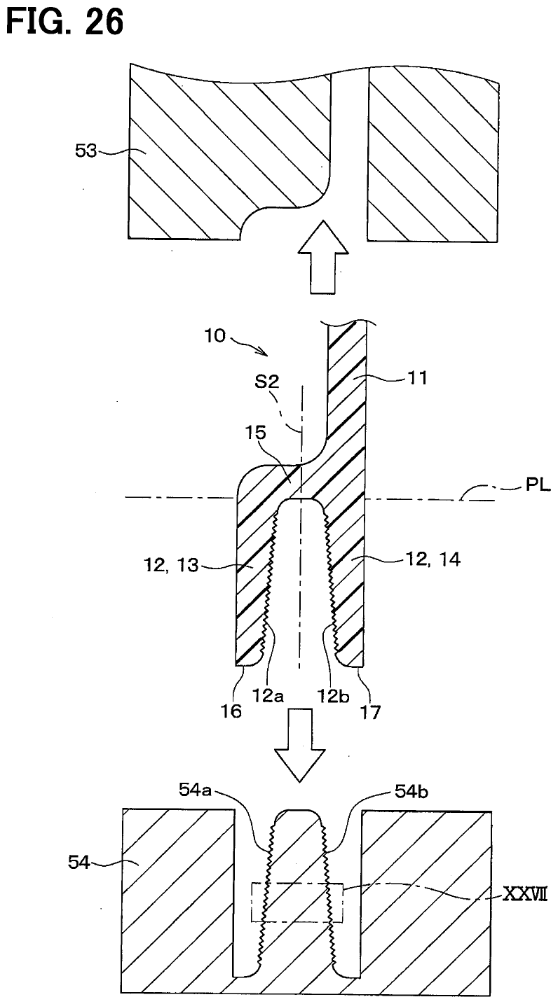

As illustrated in FIG. 26, in a mold opening process of the resin injection molding, the fourth mold 54 forming the recess 12 of the first case 10 is moved substantially in parallel to the center plane S2 of the recess 12. The irregularities indicated by reference characters 54a and 54b in FIG. 26 indicate the location of a rough surface forming portion for forming the rough surface on a resin molded product (that is, the recess 12 of the first case 10) in the fourth mold 54, and do not indicate the orientation of the irregularities of the rough surface forming portion.

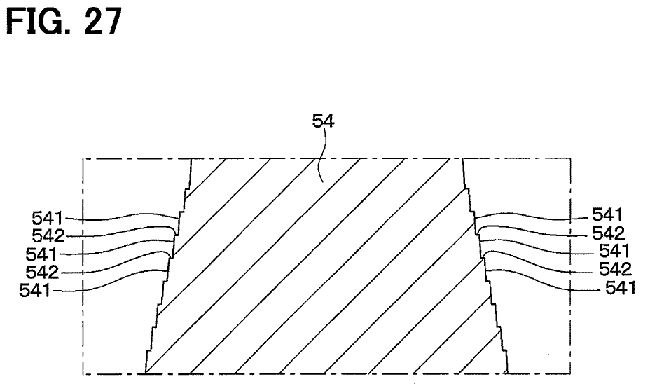

FIG. 27 is an enlarged view of the area indicated by reference character XXVII in FIG. 26, and schematically illustrates the detailed shape of the rough surface forming portion in the fourth mold 54. As illustrated in FIG. 27, the rough surface forming portion of the fourth mold 54 has a plurality of first forming surfaces 541 for forming the first surfaces 61 of the rough surface of the recess 12, and a plurality of second forming surfaces 542 for forming the second surfaces 62 of the rough surface on the protrusion 22. The plurality of first forming surfaces 541 and the plurality of second forming surfaces 542 are inclined such that the recess 12 can be cut out from the fourth mold 54. Therefore, the manufacturing method can perform mold opening by moving the fourth mold 54 substantially in parallel to the center plane S2 of the recess 12 without providing a special mold structure such as a slide core in the fourth mold 54.

In the ninth embodiment described above, the recess 12 of the first case 10 included in the air conditioner case 100 is formed into the tapered shape, so that the rough surface formed in the recess 12 can have the shape that can be formed by die cutting of normal injection molding. Therefore, the ninth embodiment can reduce the manufacturing cost by simplifying the structure of the fourth mold 54.

### OTHER EMBODIMENTS

The present disclosure is not limited to the above embodiments but can be modified as appropriate. The above embodiments are not independent of one another but can be combined as appropriate unless clearly not combinable. It goes without saying that the components included in the above embodiments are not necessarily required unless specified as being required, regarded as being clearly required in principle, or the like. The numerical value such as the number, the numerical value, the quantity, the range, or the like of the component mentioned in the above embodiments is not limited to a specific number unless specified as being required, clearly limited to such a specific number in principle, or the like. The shape, the positional relationship, and the like of the component or the like mentioned in the above embodiments are not limited to those being mentioned unless otherwise specified, limited to the specific shape, positional relationship, and the like in principle, or the like.

(1) The above embodiments describe the air conditioner case 100 that forms the outer shell of the air conditioner 1 mounted on a vehicle, but the present disclose is not limited thereto. In another embodiment, the air conditioner case 100 may form the housing of the air conditioner 1 used for a mobile body other than a vehicle, a building, or the like.

(2) The above embodiments describe that the air conditioner 1 to which the air conditioner case 100 is applied includes the blower, the evaporator, the heater core, and the like, but the present disclosure is not limited thereto. The air conditioner 1 may include a cooling device other than the evaporator or a heating device other than the heater core. Alternatively, the air conditioner 1 may include at least one of the blower, the cooling device, and the heating device.

### CONCLUSION

According to a first aspect illustrated in part or all of the above embodiments, the air conditioner case forming the housing of the air conditioner includes the first case body, the second case body, the recess, and the protrusion. The first case body forms the air duct through which air flows inside the housing. The second case body forms the air duct inside the housing together with the first case body. The recess is provided at the end of the first case body facing the second case body, and includes the inner wall facing the air duct, the outer wall located on the outer side of the housing, and the bottom that connects the inner wall and the outer wall on a side of the first case body. The protrusion is provided at the end of the second case body facing the first case body, includes the tapered portion with the thickness in a cross sectional view gradually decreasing from the second case body toward the bottom, and is fitted between the inner wall and the outer wall of the recess. The taper angle formed by the surface of the tapered portion facing the outer wall and the surface of the tapered portion facing the inner wall is larger than the internal angle formed by the surface of the outer wall facing the inner wall and the surface of the inner wall facing the outer wall.

The taper angle of the tapered portion of the protrusion is larger than the internal angle of the recess, whereby a contact surface between the protrusion and the recess (hereinafter, the contact surface between the protrusion and the recess is simply referred to as a “contact surface” in some cases) is located far from the bottom. As a result, in a state in which the protrusion and the recess are fitted together, the bottom side serves as a support and the contact surface serves as a point of application, so that the reaction force acting on the contact surface from the inner wall and the outer wall of the recess is reduced, the surface pressure acting on the contact surface is reduced, and thus the frictional resistance (that is, the friction) generated on the contact surface is reduced. The air conditioner case can thus suppress generation of a scraping noise from the contact surface.

The taper angle of the tapered portion of the protrusion is larger than the internal angle of the recess, whereby formation of a gap between the protrusion and the recess can be prevented by the elastic force of the inner wall and the outer wall of the recess even when the protrusion and the recess are shifted in position in the direction of press-fitting. The air conditioner case can thus improve the sealability of the contact surface between the protrusion and the recess.

Moreover, the reaction force acting on the contact surface from the inner wall and the outer wall of the recess is reduced when the protrusion is press-fitted into the recess, whereby the load required to press-fit the recess and the protrusion is reduced. The air conditioner case can thus improve the ease of assembly of the first case and the second case.

According to a second aspect, the recess is tapered such that the space between the inner wall and the outer wall gradually increases from the side of the bottom to the side of the second case body.

As a result, the opening of the recess formed on the side opposite to the side of the bottom can be widened. The air conditioner case can thus improve the ease of assembly of the first case and the second case.

According to a third aspect, the protrusion further includes, between the tapered portion and the second case body, the straight portion with a change in the thickness in a cross sectional view smaller than that of the tapered portion.

As a result, the contact surface between the straight portion of the protrusion and the recess is located far from the bottom. Thus, the reaction force from the inner wall and the outer wall of the recess on the straight portion is reduced, and the frictional resistance generated between the straight portion and the recess can be reduced. The air conditioner case can thus suppress generation of a scraping noise from the contact surface.

According to a fourth aspect, the protrusion further includes, on the side opposite to the side of the second case body of the tapered portion, the tip with the taper angle in a cross sectional view larger than the taper angle of the tapered portion.

With the tip provided on the protrusion, the protrusion can be easily inserted into the opening of the recess. The air conditioner case can thus improve the ease of assembly of the first case and the second case.

According to a fifth aspect, the surface roughness of at least one of the surface of the outer wall facing the tapered portion and the surface of the tapered portion facing the outer wall is higher than the surface roughness of the first case body or the second case body. Moreover, the surface roughness of at least one of the surface of the inner wall facing the tapered portion and the surface of the tapered portion facing the inner wall is higher than the surface roughness of the first case body or the second case body.

As a result, the coefficient of friction of the contact surface between the outer wall and the tapered portion can be reduced, and at the same time the coefficient of friction of the contact surface between the inner wall and the tapered portion can be reduced. Therefore, the frictional resistance on the contact surface between the protrusion and the recess is reduced. The air conditioner case can thus suppress generation of a scraping noise from the contact surface.

According to a sixth aspect, the air conditioner case forming the housing of the air conditioner includes the first case body, the second case body, the recess, and the protrusion. The first case body forms the air duct through which air flows inside the housing. The second case body forms the air duct inside the housing together with the first case body. The recess is provided at the end of the first case body facing the second case body, and includes the inner wall located on a side of the air duct, the outer wall located on the outer side of the housing, and the bottom that connects the inner wall and the outer wall facing the first case body. The protrusion is provided at the end of the second case body facing the first case body, and is fitted between the inner wall and the outer wall of the recess. Here, the surface roughness of at least one of the surface of the outer wall of the recess facing the protrusion and the surface of the protrusion facing the outer wall is higher than the surface roughness of the first case body or the second case body. Moreover, the surface roughness of at least one of the surface of the inner wall of the recess facing the protrusion and the surface of the protrusion facing the inner wall is higher than the surface roughness of the first case body or the second case body.

As a result, the coefficient of friction of the contact surface between the outer wall and the protrusion can be reduced, and the coefficient of friction of the contact surface between the inner wall and the protrusion can be reduced. Therefore, the frictional resistance on the contact surface between the protrusion and the recess is reduced. The air conditioner case can thus suppress generation of a scraping noise from the contact surface.

According to a seventh aspect, the surface roughness of at least one of the surface of the outer wall facing the protrusion and the surface of the protrusion facing the outer wall is equal to Rz 10 or higher in ten-point average roughness. Moreover, the surface roughness of at least one of the surface of the inner wall facing the protrusion and the surface of the protrusion facing the inner wall is equal to Rz 10 or higher in ten-point average roughness.

The inventor conducted the experiment to determine the load with which a scraping noise is generated by rubbing the predetermined test body to which surface roughness is imparted and another test body. As a result, it was found that, by imparting the surface roughness of Rz 10 or higher to at least one of the protrusion and the recess, the generation of a scraping noise can be suppressed effectively as compared with a conventional air conditioner case to which surface roughness is not imparted.

According to an eighth aspect, the protrusion includes the tapered portion with the thickness in a cross sectional view gradually decreasing from the second case body toward the bottom. The surface roughness of at least one of the surface of the outer wall facing the tapered portion and the surface of the tapered portion facing the outer wall is higher than the surface roughness of the first case body or the second case body. Moreover, the surface roughness of at least one of the surface of the inner wall facing the tapered portion and the surface of the tapered portion facing the inner wall is higher than the surface roughness of the first case body or the second case body.

As a result, the coefficient of friction of the contact surface between the outer wall and the tapered portion can be reduced, and at the same time the coefficient of friction of the contact surface between the inner wall and the tapered portion can be reduced. Therefore, the frictional resistance on the contact surface between the protrusion and the recess is reduced. The air conditioner case can thus suppress generation of a scraping noise from the contact surface.

What is claimed is:

1. An air conditioner case forming a housing of an air conditioner, comprising:
a first case body that defines an air duct through which air flows inside the housing;
a second case body that defines the air duct inside the housing together with the first case body;
a recess that is provided at an end of the first case body adjacent to the second case body, the recess including
an inner wall facing the air duct,
an outer wall located on an outer side of the housing, and
a bottom that connects the inner wall and the outer wall on a side of the first case body; and
a protrusion that is provided at an end of the second case body adjacent to the first case body, the protrusion including a tapered portion whose thickness in a cross sectional view gradually decreases from the second case body toward the bottom, the protrusion being fitted between the inner wall and the outer wall of the recess, wherein
a taper angle formed by a surface of the tapered portion facing the outer wall and a surface of the tapered portion facing the inner wall is larger than an internal angle formed by a surface of the outer wall facing the inner wall and a surface of the inner wall facing the outer wall,
the protrusion includes, between the tapered portion and the second case body, a straight portion in which a change in the thickness in the cross sectional view is smaller than that of the tapered portion.

2. The air conditioner case according to claim 1, wherein
the recess is tapered such that a space between the inner wall and the outer wall gradually increases from the bottom toward the second case body.

3. The air conditioner case according to claim 1, wherein
the protrusion further includes, at an end of the tapered portion farther from the second case body, a tip whose taper angle in the cross sectional view is larger than the taper angle of the tapered portion.

4. The air conditioner case according to claim 1, wherein
a surface roughness of at least one of a surface of the outer wall facing the tapered portion and the surface of the tapered portion facing the outer wall is higher than a surface roughness of the first case body or the second case body, and
a surface roughness of at least one of a surface of the inner wall facing the tapered portion and the surface of the tapered portion facing the inner wall is higher than a surface roughness of the first case body or the second case body.

5. An air conditioner case forming a housing of an air conditioner, the air conditioner case comprising:
a first case body that defines an air duct through which air flows inside the housing;
a second case body that defines the air duct inside the housing together with the first case body;
a recess that is provided at an end of the first case body adjacent to the second case body, the recess including
an inner wall facing the air duct,
an outer wall located on an outer side of the housing, and
a bottom that connects the inner wall and the outer wall on a side of the first case body; and
a protrusion that is provided at an end of the second case body adjacent to the first case body and is fitted between the inner wall and the outer wall of the recess, wherein
a surface roughness of at least one of a surface of the outer wall of the recess facing the protrusion and a surface of the protrusion facing the outer wall is higher than a surface roughness of the first case body or the second case body,
a surface roughness of at least one of a surface of the inner wall of the recess facing the protrusion and a surface of the protrusion facing the inner wall is higher than the surface roughness of the first case body or the second case body,
the surface roughness of at least one of the surface of the outer wall facing the protrusion and the surface of the protrusion facing the outer wall is equal to or higher than Rz 10 in ten-point average roughness, and
the surface roughness of at least one of the surface of the inner wall facing the protrusion and the surface of the protrusion facing the inner wall is equal to or higher than Rz 10 in ten-point average roughness.

6. The air conditioner case according to claim 5, wherein
the protrusion includes a tapered portion whose thickness in a cross sectional view gradually decreases from the second case body toward the bottom,
a surface roughness of at least one of a surface of the outer wall facing the tapered portion and a surface of the tapered portion facing the outer wall is higher than the surface roughness of the first case body or the second case body, and
a surface roughness of at least one of a surface of the inner wall facing the tapered portion and a surface of the tapered portion facing the inner wall is higher than the surface roughness of the first case body or the second case body.
